(19) United States
(12) Patent Application Publication
(10) Pub. No.: US 2026/0258998 A1
(43) Pub. Date: Sep. 3, 2026

(54) REFRIGERATOR

(71) Applicant: LG ELECTRONICS INC., Seoul (KR)

(72) Inventors: Sanggyun LEE, Seoul (KR); Younseok LEE, Seoul (KR); Yongwon DONG, Seoul (KR)

(73) Assignee: LG ELECTRONICS INC., Seoul (KR)

(21) Appl. No.: 18/877,569

(22) PCT Filed: May 9, 2023
(86) PCT No.: PCT/KR2023/006249

§ 371 Date: Dec. 20, 2024

(30) Foreign Application Priority Data
Jun. 21, 2022 (KR) 10-2022-0075360
Jun. 21, 2022 (KR) 10-2022-0075361

(51) Int. Cl. F25D 23/02; E05F 1/12

(52) U.S. Cl. CPC F25D 23/028; E05F 1/1215; E05Y 2201/22; E05Y 2900/31; F25D 2323/024

(57) ABSTRACT

A refrigerator according to the embodiment may include a cabinet having a storage space. The refrigerator may further include a hinge bracket that is coupled to the cabinet and has a contact surface. The refrigerator may further include a door that is rotatably coupled to a shaft provided in the hinge bracket and opens and closes the storage space. The refrigerator may further include an auto closing device that is installed on the door at a position spaced apart from a rotation center (C1) of the door and operates such that the door is automatically closed, by interacting with the hinge bracket while the door is being closed. The auto closing device may include a lever that rotates about a rotation center (C2) spaced apart from the rotation center (C1) of the door. The auto closing device may further include an elastic member connected to the lever. The auto closing device may further include a body that is installed on the door and rotatably supports the lever. The auto closing device may further include a locking member that can rotate about a rotation center (C3) spaced apart from the rotation center (C2) of the lever and is coupled to the lever in a state in which elastic forces of the elastic member are accumulated or while the door is being opened, to thereby limit the rotation of the lever.

### TECHNICAL FIELD

The present disclosure relates to a refrigerator.

### BACKGROUND ART

In general, a refrigerator is a home appliance for storing food at a low temperature in a storage space that is covered by a refrigerator door. The refrigerator is configured to keep stored food in an optimal state by cooling the inside of the storage space using cold air generated through heat exchange with a refrigerant circulating in a refrigeration cycle.

The refrigerator may be placed independently in a kitchen or a living room or may be accommodated in a kitchen cabinet.

The refrigerator tends to increase in size more and more, and multi-functions are provided to the refrigerator as dietary life changes and pursues high quality, and accordingly, refrigerators of various structures in consideration of user convenience are, brought to the market.

The refrigerator may include a cabinet defining a storage space and a door connected to the cabinet and having the storage space. A door storage portion for storing food may be provided in the door. When the door storage portion is provided in the door, a lot of force is required for the user to close the door due to a weight of the food stored in the door storage portion as well as a weight of the door itself.

In order for the user to easily close the door, the recent refrigerator is provided with a hinge device for automatically closing the door when the door is closed at a certain angle.

An automatic return hinge device including a restoring device is disclosed in Korean Patent Registration No. 10-0874633, which is a prior document.

The hinge device may include a body, a clutch device mounted inside the body, a shaft coupled to pass through the clutch device, and a first spring that transmits restoring force to the shaft when the door is closed.

The shaft serves to provide a rotational center of the door, and the first spring in the form of a coil spring is disposed in a direction parallel to the shaft.

In the case of the prior document, since the restoration device is disposed in a direction parallel to the rotational center of the door, a space for positioning the restoration device as high as the height of the restoration device is required in the door, and thus, there is a restriction in installing the restoration device.

In addition, the position of the rotational center of the door may vary according to a thickness of the door, and when the thickness of the door becomes thin, it may be impossible to install the restoration device in a direction parallel to the rotational center of the door.

### DISCLOSURE

### Technical Problem

Embodiments provide a refrigerator in which a user operates an auto closing device by rotating a door at a minimum angle when the door reaches a reference angle during a closing process so that the user closes the door with little force.

Optionally or additionally, embodiments provide a refrigerator in which, when a user removes force for closing a door in a process of closing the door, an auto closing device does not operate to prevent a phenomenon, in which the door is maintained in an opened state, from occurring.

Optionally or additionally, embodiments provide a refrigerator provided with an auto closing device installed in a door regardless of a thickness of a door to provide closing force of the door.

### Technical Solution

In one embodiment, a refrigerator may include a cabinet having a storage space. The refrigerator may further include a hinge bracket coupled to the cabinet and having a contact surface. The refrigerator may further include a door rotatably coupled to a shaft provided in the hinge bracket and that opens or closes the storage space. The refrigerator may further include an auto closing device installed on the door at a position spaced apart from a rotation center C1 of the door, and that operates to automatically close the door by acting on the hinge bracket in a process of closing the door.

The auto closing device may include a lever that rotates with respect to a rotation center C2 spaced apart from the rotation center C1 of the door. The auto closing device may further include an elastic member connected to the lever.

The auto closing device may further include a locking member coupled to the lever to limit a rotation of the lever. The locking member is rotatable with respect to a rotation center C3 spaced apart from the rotation center C2 of the lever.

The locking member may be coupled to the lever while an elastic force of the elastic member is accumulated or in the process of opening the door.

The auto closing device may further include a body to rotatably support the lever.

When the door is closed, the elastic force of the elastic member may be a second elastic force. In a state in which a rotation of the lever is limited, the elastic force of the elastic member may be a first elastic force that is greater than the second elastic force. The door may be further opened while the rotation of the lever is restricted.

The auto closing device may further include a housing coupled to the body or the door and that rotatably supports the locking member. The auto closing device may further include an elastic member that elastically supports the locking member within the housing.

The lever may include a locking groove. The locking member may include a hook inserted into the locking groove. When the hook is inserted into the locking groove, a rotation of the lever may be restricted.

In the process of closing the door, the lever may move along the contact surface.

The lever may include an extension portion configured to rotate the locking member in another direction while the lever is rotated in one direction with respect to the rotation center C2.

The locking groove may be formed between the contact portion in contact with the contact surface and the extension portion in the lever.

A distance from the rotation center C2 to an end of the extension portion may be less than a distance from the rotation center C2 to the contact portion of the lever in contact with the contact surface.

The locking member may further include a receiving groove in which the extension portion is received in a locked state in which the rotation of the lever is restricted. The locking member may further include a contact protrusion that is pressed by the extension portion during a rotation of the lever in one direction. The receiving groove may be disposed between the rotation center C3 of the locking member and the contact protrusion.

The auto closing device may further include a push member that pushes the lever or the locking member to unlock the lever with respect to the locking member during the process of closing the door. In the process of closing the door, the push member pushes the lever so that the lever is rotated in one direction with respect to the rotation center C2, the locking member is rotated in another direction with respect to the rotation center C3 by the rotation of the lever in one direction, to unlock the lever.

The contact surface may include a first surface. In the process of closing the door after the door is opened at an angle greater than a reference angle, the lever rotated by the push member may contact the first surface. The contact surface may further include a second surface extending to be inclined from the first surface. The contact surface may further include a third surface extending to be inclined from the second surface. In a state in which the door is closed, the lever may contact the third surface.

As the first surface approaches the front surface of the cabinet, the first surface may extend in a direction closer to the rotation center C1. As the second surface approaches the front surface of the cabinet, the second surface may extend in a direction closer to the rotation center C1, and may have a different curvature from the first surface. The third surface may extend from the second surface in a direction away from a front surface of the cabinet. In the process of moving the lever from the first surface to the second surface, the lever may be spaced apart from the push member.

The locking member may further include a rounded surface positioned between the hook and the contact protrusion. In the process of moving the lever from the first surface to the second surface, the extension portion may be in contact the rounded surface after passed the contact protrusion.

The lever may include a rotatable roller. In the process of closing the door, the push member may push the roller.

The push member may be spaced apart from the contact surface in a horizontal direction. In the process of closing the door, the lever may pass through a space between the push member and the contact surface.

The push member may be installed on the hinge bracket or the cabinet.

In another embodiment, a refrigerator may include a cabinet having a storage space. The refrigerator may include a hinge bracket coupled to the cabinet and having a contact surface. The refrigerator may include a door rotatably coupled to a shaft provided in the hinge bracket and that opens or closes the storage space. The refrigerator may further include a body installed on the door at a position spaced apart from a rotation center of the door. The refrigerator may further include a lever that is rotatably supported on the body and rotates with respect to a rotation center C2 spaced apart from a rotation center C1 of the door. The refrigerator may further include an elastic member connected to the lever.

The refrigerator may further include a locking member rotatable with respect to a rotation center C3 spaced apart from the rotation center C2 of the lever and to limit a rotation of the lever. The refrigerator may further include a push member for releasing the locking of the lever by the locking member during the process of closing the door.

When the door is opened at an angle greater than a reference angle, the lever may be in a locked state in which rotation is restricted by the locking member while the elastic member accumulates elastic force. After the door is opened at an angle greater than the reference angle, the push member may push the lever or the locking member in the process of closing the door, thereby unlocking the lever.

When the lever moves along the contact surface in a state in which the lever is unlocked, the elastic force accumulated in the elastic member may decrease. In a section where the elastic force of the elastic member is decreased, the elastic force of the elastic member acts as a closing force of the door, allowing the door to be closed.

In further another embodiment, a refrigerator may include an auto closing device that operates to automatically close the door. The auto closing device may include a lever that rotates with respect to a rotation center C2 spaced apart from the rotation center C1 of the door. The auto closing device may include an elastic member connected to the lever. The auto closing device may further include a body installed on the door and that rotatably supports the lever. The auto closing device may further include a locking member rotatable with respect to a rotation center C3 spaced apart from the rotation center C2 of the lever. The locking member may be coupled to the lever and limit a rotation of the lever while the lever is rotated in a direction in which the elastic force of the elastic member increases during the opening of the door.

The auto closing device may further include a housing coupled to the body or the door and that rotatably supports the locking member. The auto closing device may further include an elastic member that elastically supports the locking member within the housing.

The lever may include a locking groove. The locking member may include a hook inserted into the locking groove. When the hook is inserted into the locking groove, a rotation of the lever may be restricted.

The refrigerator may further include a hinge bracket that may contact the lever. The hinge bracket may include a contact surface that contacts the lever during the opening and closing process of the door.

During the closing of the door, the lever rotates while the lever moves along the contact surface, and the locking member may rotate according to the rotation of the lever.

The contact surface may include a first surface that contacts the lever when an opening angle of the door reaches a reference angle during the process of closing the door after the door is opened at an angle greater than the reference angle. While the lever moves along the first surface, the lever may be rotated in one direction with respect to the rotation center C2. The locking member may be rotated in one direction with respect the rotation center C3 by rotating the lever to unlock the lever.

The contact surface may further include a second surface extending to be inclined from the first surface. The contact surface may further include a third surface extending to be inclined from the second surface and that contacts the lever in a state in which the door is closed.

As the first surface approaches a front surface of the cabinet, the first surface may extend in a direction away from the rotation center C1 of the door. As the first surface approaches a front surface of the cabinet, the second surface may extend in a direction closer to the rotation center C1. The third surface may extend from the second surface in a direction away from a front surface of the cabinet.

The lever may further include an extension portion for rotating the locking member while the lever is rotated in one direction with respect to the rotation center C2. The locking groove may be formed between the contact portion in contact with the contact surface in the lever and the extension portion. The locking member may include a receiving groove in which the extension portion is received in a locked state in which a rotation of the lever is restricted. The locking member may further include a contact protrusion that is pressed by the extension portion while the lever is rotated in one direction with respect to the rotation center C2. The contact protrusion may be located between the rotation center C3 and the receiving groove.

In the process of moving the lever from the first surface to the second surface, the lever is rotated in another direction with respect to the rotation center C2, and the locking member is also rotated in another direction with respect to the rotation center C3.

In the process of moving the lever from the first surface to the second surface, the extension portion may be received in the receiving groove of the locking member.

The second surface may include a concave surface connected to the first surface. The second surface may further include a convex surface connected to the third surface.

In the process of moving the lever from the second surface to the third surface, the lever is rotated in another direction with respect to the rotation center C2, and the locking member is rotated in the one direction with respect to the rotation center C3.

In further another embodiment, a refrigerator may include a cabinet having a storage space. The refrigerator may further include a hinge bracket coupled to the cabinet and having a contact surface. The refrigerator may further include a door rotatably coupled to a shaft provided in the hinge bracket and that opens or closes the storage space. The refrigerator may further include an auto closing device that is installed on the door at a position spaced apart from a rotation center of the door and operates to automatically close the door by acting on the hinge bracket during the process of closing the door.

The auto closing device may include a lever that rotates with respect to a rotation center C2 spaced apart from the rotation center C1 of the door. The auto closing device may further include an elastic member connected to the lever. The auto closing device may further include a body installed on the door and that rotatably supports the lever. The auto closing device may further include a locking member rotatable with respect to a rotation center C3 spaced apart from the rotation center C2 of the lever. When the door is opened at an angle greater than a reference angle, the lever may be in a locked state in which a rotation is restricted by the locking member while the elastic member accumulates elastic force. After the door is opened at an angle greater than the reference angle, in the process of closing the door, the lever contacts the contact surface to rotate the lever, and a rotational force of the lever is transmitted to the locking member to rotate the locking member, and thereby unlocking the lever.

The locking member may unlock the lever by rotating in the same direction as the lever. To unlock the lever, a rotation angle of the lever when the lever is rotated in one direction may be different from a rotation angle when the locking member is rotated in one direction.

In further another embodiment, a refrigerator may include an auto closing device that operates to automatically close the door by acting on a hinge bracket during the closing of the door. The auto closing device may include a lever that rotates with respect to a rotation center C2 spaced apart from the rotation center C1 of the door. The auto closing device may include an elastic member connected to the lever. The auto closing device may further include a locking member rotatable with respect to a rotation center C3 spaced apart from the rotation center C2 of the lever. When the door is opened at an angle greater than the reference angle, the lever may be in a locked state in which a rotation is restricted by the locking member while the elastic member accumulates first elastic force. In the process of closing the door after the door is opened at an angle greater than the reference angle, while the lever moves along a portion of the contact surface, an elastic force of the elastic member increases than a first elastic force and the locking of the lever by the locking member may be released. While the lever moves along another portion of the contact surface, the elastic force accumulated in the elastic member may decrease. In a section where the elastic force of the elastic member is decreased, the elastic force of the elastic member may act as a closing force of the door.

In a state in which the door is closed, the elastic force of the elastic member may be maintained as a second elastic force less than the first elastic force and greater than zero.

### Advantageous Effects

According to the proposed invention, when the user rotates the door at the minimum angle at a time point at which the door reaches a reference angle, since the auto closing device operates to automatically close the door, the user may close the door with the little force.

In a state in which the lever is unlocked, since the lever receives the elastic force of the elastic member, the door may be automatically closed by the elastic force of the elastic member without manually closing the door by the user. Therefore, in the process of closing the door, when the user releases the door, a phenomenon in which the door is maintained in an opened state may be prevented from occurring.

In addition, since the auto closing device is disposed to be spaced apart from a rotational center line of the door, even when a thickness of the door is decreased, a closing force may be provided to the door while the door is closed.

### DESCRIPTION OF DRAWINGS

FIG. 1 is a front view of a refrigerator according to a first embodiment of the present invention.

FIG. 2 is an enlarged view illustrating a portion A of FIG. 1.

FIG. 3 is perspective view illustrating relative positions of a hinge bracket and an auto closing device in a state in which the door is closed.

FIG. 4 is a perspective view showing relative positions of a hinge bracket and an auto closing device in a state in which the door is opened at a reference angle.

FIG. 5 is an exploded perspective view of an auto closing device.

FIG. 6 is a bottom view of an auto closing device and a hinge bracket showing relative positions of the hinge bracket and the auto closing device in a state in which the door is opened at a reference angle.

FIG. 7 is a bottom view of an auto closing device and a hinge bracket showing relative positions of the hinge bracket and the auto closing device in a state in which the door is opened by a first angle less than the reference angle.

FIG. 8 is a bottom view of an auto closing device and a hinge bracket showing elative positions of the hinge bracket and the auto closing device in a state in which the door is opened by a second angle less than the first angle.

FIG. 9 is a bottom view of an auto closing device and a hinge bracket showing relative positions of the hinge bracket and the auto closing device in a state in which the door is opened by a third angle less than the second angle.

FIG. 10 is a bottom view of an auto closing device and a hinge bracket showing relative positions of the hinge bracket and the auto closing device in a state in which the door is opened by a fourth angle less than the third angle.

FIG. 11 is a bottom view of an auto closing device and a hinge bracket showing relative positions of the hinge bracket and the auto closing device when the door is closed.

FIG. 12 is a perspective view showing relative positions of a hinge bracket and an auto closing device in a state in which the door is closed according to a second embodiment of the present invention.

FIG. 13 is a perspective view showing relative positions of a hinge bracket and an auto closing device in a state in which the door is opened at a reference angle according to a second embodiment.

FIG. 14 is an exploded perspective view of an auto closing device according to a second embodiment.

FIG. 15 is a bottom view of an auto closing device and a hinge bracket showing relative positions of the hinge bracket and the auto closing device in a state in which the door is opened at a reference angle according to a second embodiment.

FIG. 16 a bottom view of an auto closing device and a hinge bracket showing relative positions of the hinge bracket and the auto closing device in a state in which the door is opened by a first angle less than the reference angle according to a second embodiment.

FIG. 17 is a bottom view of an auto closing device and a hinge bracket showing relative positions of the hinge bracket and the auto closing device in a state in which the door is opened by a second angle less than the first angle according to a second embodiment.

FIG. 18 is a bottom view of an auto closing device and a hinge bracket showing relative positions of the hinge bracket and the auto closing device in a state in which the door is opened by a third angle less than the second angle according to a second embodiment.

FIG. 19 is a bottom view of an auto closing device and a hinge bracket showing relative positions of the hinge bracket and the auto closing device in a state in which the door is opened by a fourth angle less than the third angle, according to a second embodiment.

FIG. 20 is a bottom view of an auto closing device and a hinge bracket showing relative positions of the hinge bracket and the auto closing device in a state in which the door is opened by a fifth angle less than the fourth angle according to a second embodiment.

FIG. 21 is a bottom view of an auto closing device and a hinge bracket showing relative positions of the hinge bracket and the auto closing device in a state in which the door is closed according to a second embodiment.

### MODE FOR INVENTION

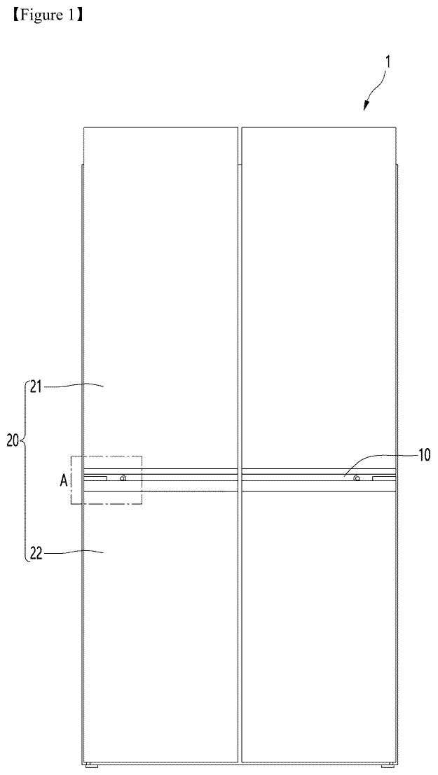

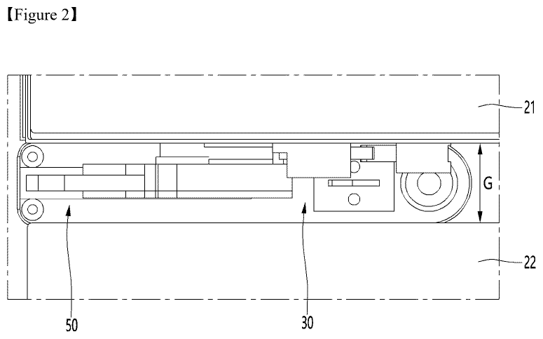

FIG. 1 is a front view of a refrigerator according to a first embodiment of the present invention and FIG. 2 is an enlarged view illustrating a portion A of FIG. 1.

Referring to FIGS. 1 and 2, a refrigerator 1 according to an embodiment may be installed independently in a kitchen or installed in an indoor furniture cabinet. When the refrigerator 1 is installed in the indoor furniture cabinet, the refrigerator 1 may be installed alone or arranged side by side with the other refrigerator.

The refrigerator 1 may include a cabinet 10 having a storage space. The refrigerator 1 may include a refrigerator door 20 that opens or closes the storage space.

The storage space may not be limited, but may be divided into an upper first space and a lower second space. The refrigerator door 20 may also include a first door 21 that opens and closes the first space and a second door 22 that opens and closes the second space.

The first space may be a refrigerating compartment, and the second space may be a freezing compartment or vice versa. Alternatively, the storage space may include a first space and a second space, which are divided into left and right sides. Alternatively, the storage space may be a single space, and a single refrigerator door may open and close the storage space.

At least one or more of the first door 21 and the second door 22 may be a rotation type door. Alternatively, the single refrigerator door 20 may be a rotation type door.

In the case of this embodiment, the refrigerator door 20 may include an auto closing device 30 that provides a closing force to the refrigerator door 20 during the process of closing the refrigerator door 20. In FIG. 2, for example, an auto closing device 30 is provided in the first door among the first and second doors arranged in the vertical direction. It should be noted that the position of the auto closing device 30 is not limited.

When the first door 21 and the second door 22 are arranged in the vertical direction, a hinge bracket 50 is provided between the first door 21 and the second door 22. The hinge bracket 50 may be a common bracket that provides a rotational center of each of the first door 21 and the second door 22. Alternatively, the hinge bracket may be disposed at an upper side of the first door 21, and the hinge bracket may also be disposed at a lower side of the second door 22. The hinge bracket 50 may be fixed to a front surface of the cabinet 10. The hinge bracket 50 may include a shaft member 550 (to be described later).

A gap G having a predetermined size may be defined between the first door 21 and the second door 22. A portion of the hinge bracket 50 is disposed between the first door 21 and the second door 22 so that the first door 21 and the second door 22 rotate without interfering with each other. At least a portion of the hinge bracket 50 may be spaced apart from a lower surface of the first door 21 as well as an upper surface of the second door 22.

The auto closing device 30 according to this embodiment may provide closing force to the first door 21 in a process of closing the first door 21 while acting with the hinge bracket 50. Of course, when the auto closing device 30 is provided on the second door 22, it is also possible to provide closing force to the second door 22.

In order for the auto closing device 30 to provide the closing force to the first door 21, the auto closing device 30 may be installed in the first door 21. For example, the auto closing device 30 may be installed at a lower side of the first door 21. In order to interact with the hinge bracket 30, a portion of the auto closing device 30 may protrude downward from a lower surface of the first door 21. Of course, the auto closing device 30 may be installed at an upper side of the first door 21.

When the auto closing device 30 is installed at the lower side of the first door 21, the auto closing device 30 may not be well seen from the outside while the first door 21 is opened and closed. The auto closing device 30 may be spaced apart from an upper surface of the second door 22 so that the auto closing device 30 does not interfere with the second door 22.

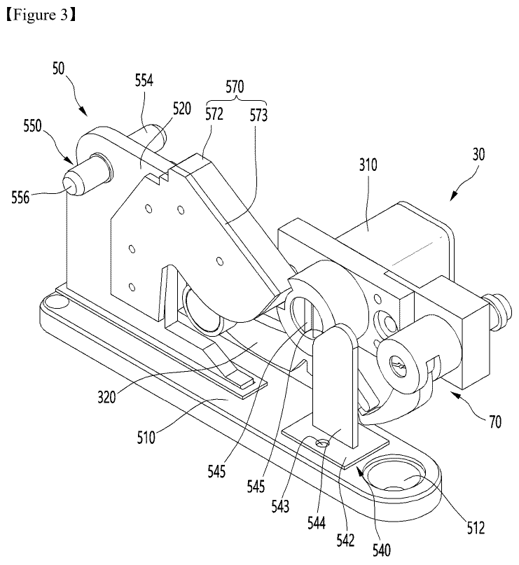

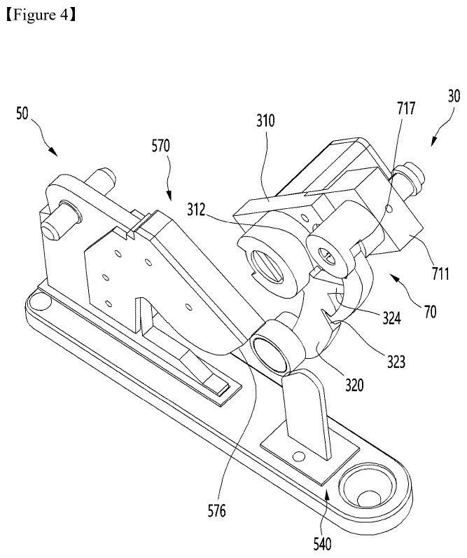

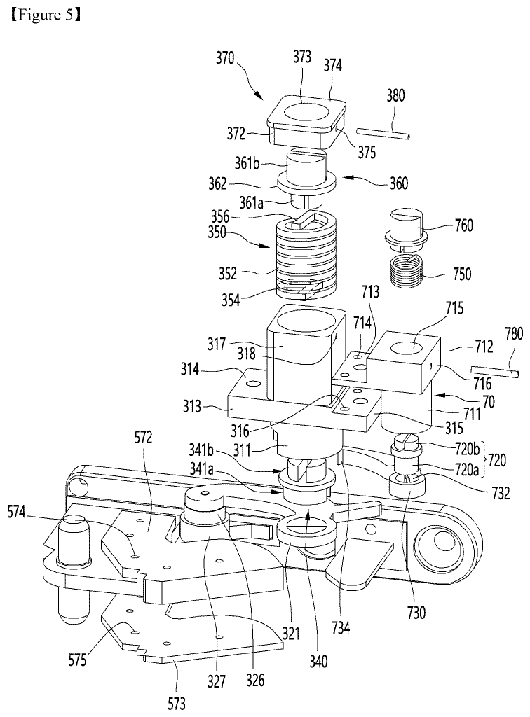

FIG. 3 is perspective view illustrating relative positions of a hinge bracket and an auto closing device in a state in which the door is closed, FIG. 4 is a perspective view showing relative positions of a hinge bracket and an auto closing device in a state in which the door is opened at a reference angle, and FIG. 5 is an exploded perspective view of an auto closing device.

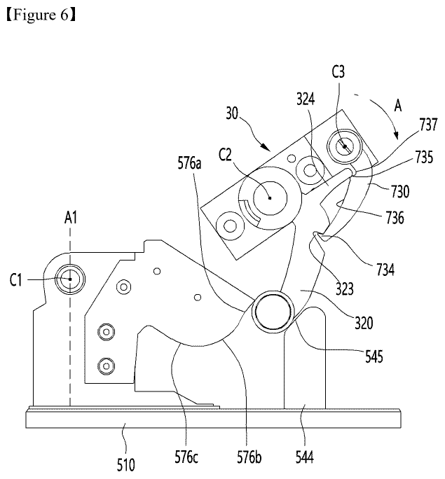

FIG. 6 is a bottom view of an auto closing device and a hinge bracket showing relative positions of the hinge bracket and the auto closing device in a state in which the door is opened at a reference angle.

Referring to FIGS. 3 to 6, the hinge bracket 50 may include a coupling portion 510 to be coupled to the cabinet 10. The hinge bracket 50 may further include a bracket body 520 extending in a horizontal direction from the coupling portion 510.

The coupling portion 510 may include one or more coupling holes 512. A coupling member may be coupled to the cabinet 10 through the coupling hole 512. A shaft member 550 may be coupled to the bracket body 520. The shaft member 550 may include a first shaft 554 that provides a rotation center of the first door 21. The shaft member 550 may further include a second shaft 556 that provides a rotation center of the second door 22. Of course, the second shaft 556 can be omitted.

The shaft member 550 may further include a seating portion 552 seated on the bracket body 520. The first shaft 554 may extend upward from the seating portion 552. The second shaft 556 may extend downward from the seating portion 552. A diameter of the seating portion 552 may be greater than a diameter of the second shaft 556. A hole (not shown) through which the second shaft 556 passes may be formed in the bracket body 520. The first door 21 may be coupled to the first shaft 554. The second door 22 may be coupled to the second shaft 556.

The hinge bracket 50 may further include a cam member 570 that is detachably coupled to the bracket body 520.

The cam member 570 may include a contact surface 576 for contacting the lever 320. When the contact surface 576 is worn, the cam member 570 may be separated from the bracket body 520 and then a new cam member 570 may be coupled to the bracket body 520. When the cam member 570 is detachably coupled to the bracket body 520, only the cam member 570 may be replaced without replacing the entire hinge bracket 50 and there is an advantage of reducing service costs.

Since the cam member 570 is detachably coupled to the bracket body 520, the cam member 570 may be separated while the first door 21 and the second door 22 are opened. Therefore, it has an advantage of being easy to service. That is, since there is no need to separate the doors, there is an advantage that the cam member may be easily replaced. Of course, it is also possible for the cam member 570 to be formed integrally with the bracket body 520. In this case, the bracket body 520 may include a contact surface 576.

The cam member 570 may include a first cam body 572 and a second cam body 573 coupled to the first cam body 572. The first cam body 572 and the second cam body 573 may be coupled by a coupling member via the bracket body 520. For example, in a state in which a portion of the first cam body 572 is positioned above the bracket body 520 and a portion of the second cam body 573 is positioned below the bracket body 520, the first cam body 572 is coupled to the second cam body 573. The first cam body 572 may include one or more coupling holes 574. The second cam body 573 may include one or more coupling holes 575. A coupling hole aligned with each of the coupling holes 574 and 575 may also be formed in the bracket body 520.

A portion of the first cam body 572 may provide a portion of the contact surface 576, and a portion of the second cam body 573 may provide another portion of the contact surface 576. Alternatively, it is possible for only one of the first cam body 572 and the second cam body 573 to provide the contact surface 576.

The auto closing device 30 may be disposed at a position spaced apart from the first shaft 554 in the horizontal direction. That is, the auto closing device 30 may be coupled to the first door 21 at a position spaced apart from the first shaft 554. The auto closing device 30 may rotate together with the first door 21 and the auto closing device 30 may interact with the bracket body 520 in a process of closing the first door 21 to provide the closing force to the first door 21.

Hereinafter, the auto closing device 30 will be described in detail.

The auto closing device 30 according to this embodiment may include a body 310. The auto closing device 30 may further include a lever 320 rotatably coupled to the body 310. The auto closing device 30 may further include an elastic member 350 connected to the lever 320.

The body 310 may define an outer appearance of the auto closing device 30. The lever 320 may be rotated in a horizontal direction with respect to the rotation center (C2: see FIG. 6). That is, a line passing through the rotation center of the first door 21 (C1: see FIG. 6) and a line passing through the rotation center of the lever 320 (C2: see FIG. 6) are parallel and may be spaced apart in the horizontal direction.

The body 310 may receive a portion of the lever 320. For example, the body 310 may include a first body 311 that receives a portion of the lever 320. The first body 311 may be provided with a slot 312 for insertion of the lever 320. In a state in which the lever 320 is inserted into the first body 311, the lever 320 may be rotated. Accordingly, the slot 312 may extend in a circumferential direction of the first body 311 to enable rotation of the lever 320.

The body 310 may further include a second body 313 located above the first body 311. The second body 313 may be coupled to the first door 21. The second body 313 may be formed integrally with the first body 311 or may be coupled to the first body 311.

For example, the first body 311 may be formed in a cylindrical shape. For example, the second body 313 may be formed in a rectangular parallelepiped shape. One or more coupling holes 314 may be formed in the second body 313. Each of the first body 311 and the second body 313 may include an opening penetrating in a vertical direction. The opening of the first body 311 may communicate with the opening of the second body 313.

The body 310 may further include a third body 317 located above the second body 313. For example, the third body 317 may be coupled to an upper side of the second body 313.

The auto closing device 30 may further include a first connector 340 disposed within the body 310. The first connector 340 may be connected to the lever 320 inserted into the body 310. The first connector 340 may be connected to the lever 320 and rotated together with the lever 320. The first connector 340 may be received in the body 310 from an upper side of the body and coupled to the lever 310 in a state in which the lever 320 is inserted into the body 310 through the slot 312. A portion of the first connector 340 may pass through the lever 320 and be coupled to the lever 320.

The first connector 340 may connect the elastic member 350 to the lever 320. The first connector 340 may include a lever coupling portion 341a. The lever coupling portion 341a may be coupled to the lever 320.

The first connector 340 may include a first elastic member coupling portion 341b coupled to the elastic member 350. The first connector 340 may further include a partition plate 342 disposed between the lever coupling portion 341a and the first elastic member coupling portion 341b. Based on the partition plate 342, the lever coupling portion 341a may be provided at a lower side of the partition plate 342, and the first elastic member coupling portion 341b may be provided at an upper side of the partition plate 342.

The lever coupling portion 341a may include a first rib and a second rib spaced apart in the horizontal direction. A first coupling space may be formed between the first rib and the second rib. As another example, the lever coupling portion 341a may be formed in a single rib shape or may be formed in a non-circular shape. The lever 320 may include a plurality of rib holes through which the first and second ribs respectively pass. The plurality of rib holes may be spaced apart from each other. When the lever coupling portion 341a includes one rib, the lever 320 may also include one rib hole of a shape corresponding to the rib.

The first elastic member coupling portion 341b may include a third rib and a fourth rib spaced apart in the horizontal direction. A second coupling space may be formed between the third rib and the fourth rib. A portion of the elastic member 350 may be received in the coupling space.

The lever 320 may include a first portion 321 coupled to the first connector 340. The first portion 321 may also be referred to as a connector coupling portion. A portion of the first portion 321 may pass through the slot 312 and be received in the body 310. Another portion of the first portion 321 may be located at the body 310. The rib hole may be formed in the first portion 321.

The lever 320 may further include a second portion 322 extending from the first portion 321 in a horizontal direction. For example, the second portion 322 may extend while maintaining the same height as the first portion 321. The lever 320 may further include a contact portion for contacting the bracket body 520. For example, the contact portion may be a roller 327. The roller 327 may be rotatably coupled to the second portion 322 by a roller pin 326. For example, the roller 327 may be disposed at lower side of the second portion 322.

The lever 320 may further include a third portion 324 extending from the first portion 321 in a direction different from an extending direction of the second portion 322. The third portion 324 may function with a locking member 70, which will be described later. The third portion 324 may be referred to as an extension portion.

The elastic member 350 may be, for example, a torsion spring. The elastic member 350 may include a body portion 352 provided by winding a wire multiple times. The body portion 352 may have a cylindrical or truncated cone shape.

The elastic member 350 may include a first extension portion 354 extending in the horizontal direction from a lower end of the body portion 352. The first extension portion 354 may extend toward a center of the body portion 352. The first extension portion 354 may be coupled to the first connector 340. For example, the first extension portion 354 may be inserted into the second coupling space 348 of the first elastic member coupling portion 341b. When the first extension portion 354 is received in the second coupling space 348, the first elastic member coupling portion 341b may be received into the body portion 352. In a state in which the first extension portion 354 is received in the second coupling space 348, the first extension portion 354 and the body portion 352 may be seated on the partition plate 342. The elastic member 350 may further include a second extension portion 356 extending in the horizontal direction from an upper end of the body portion 352.

The auto closing device 30 may further include a second connector 360 coupled to the elastic member 350. The second extension portion 356 may be coupled to the second connector 360. The second connector 360 may include a second elastic member coupling portion 361a. The second connector 360 may further include a pin coupling portion 361b. The second connector 360 may further include a partition plate 362 disposed between the second elastic member coupling portion 361a and the pin coupling portion 361b. Based on the partition plate 362, the pin coupling portion 361b may be provided at an upper side of the partition plate 342. The second elastic member coupling portion 361a may be provided at a lower side of the partition plate 362.

Since a basic structure of the second elastic member coupling portion 361a may be the same or similar to that of the first elastic member coupling portion 341a, detailed description will be omitted.

Since a basic structure of the pin coupling portion 361b may be the same or similar to that of the second elastic member coupling portion 361a, detailed description will be omitted.

The auto closing device 30 may further include an upper cap 370 to cover an upper opening of the body 310. The upper cap 374 may include a cap body 372 having a hollow 373 therein. The upper cap 374 may further include a flange 374 extending from an upper end of the cap body 372 in the horizontal direction. Of course, the upper cap 370 can be omitted. The cap body 372 may be inserted into the body 310. The flange 374 may be seated on an upper surface of the body 310. The pin coupling portion 361b may be inserted into the hollow 373.

The auto closing device 30 may further include a fixing pin 380. The fixing pin 380 may limit a rotation of the second connector 360. The fixing pin 380 may fix the upper cap 370 to the body 310.

A pair of first pin holes 318 through which the fixing pin 380 passes may be formed in the body 310. A pair of second pin holes 375 through which the fixing pin 380 passes may be formed in the cap body 372. The fixing pin 380 may be inserted into the pin coupling portion 361b. That is, after passing through one first pin hole 318 and one second pin hole 375, the fixing pin 380 may pass through the pin coupling portion 361b and pass through the other second pin hole 375 and the other first pin hole 318.

The positions of the upper cap 370 and the second connector 360 may be fixed to the body 310 by the fixing pin 380. That is, rotation of the upper cap 370 and the second connector 360 may be restricted by the fixing pin 380.

In this embodiment, the second extension portion 356 of the elastic member 350 is a fixed end, and the first extension portion 354 is a movable end. Thus, in a state in which the second extension portion 356 is fixed, the first extension portion 354 is rotatable together with the lever 320.

When the first extension portion 354 of the elastic member 350 rotates in one direction while the second extension portion 356 is fixed, the elastic member 350 accumulates the elastic force. The elastic force accumulated by the elastic member 350 may act as the lever 320 so that the lever 320 rotates in another direction opposite to the one direction. In this manner, the elastic force accumulated by the elastic member 350 substantially acts on the first door 21 in the process of closing the first door 21 so that the first door 21 is automatically closed at a predetermined position.

The auto closing device 30 may further include a locking unit 70. The locking unit 70 may limit a rotation of the lever 320 when the first door 21 is opened at an angle equal to or greater than a predetermined angle.

In the process of opening the first door 21, the elastic force of the elastic member 350 may be accumulated, and in the process of increasing the elastic force of the elastic member 350, when the first door 21 may be opened at the predetermined angle, the locking unit 70 may be connected to the lever 320 to limit the rotation of the lever 320.

The locking unit 70 may include a locking member 730 that is rotatable with respect to the lever 320. The locking member 730 may be rotated independently of the lever 320. The locking member 730 may be coupled to or disengaged from the lever 320.

When the locking member 730 is coupled to the lever 320, a rotation of the lever 320 may be restricted. When the locking member 730 is disengaged from the lever 320, the lever 320 may be rotated.

The locking unit 70 may further include a housing 710 to which the locking member 730 is rotatably connected. The housing 710 may include a hollow 715 extending in a vertical direction. The housing 710 may receive a portion of the locking member 730. For example, the housing 710 may include a first housing 711. The locking member 730 may be received in the first housing 711.

The first housing 711 may be provided with a slot 717 for insertion of the locking member 730. A portion of the locking member 730 that passed the slot 717 may be located in the hollow 715.

When the locking member 730 is inserted into the first housing 711, the locking member 730 may be rotated with respect to the first housing 711. Accordingly, the slot 717 may extend in a circumferential direction of the first housing 711 to enable rotation of the locking member 730.

The housing 710 may further include a second housing 712 located above the first housing 711. The second housing 712 may be coupled to the first door 21 or the body 310. Hereinafter, the second housing 712 is coupled to the body 310 as an example. The second housing 712 may include a coupling extension portion 713 extending in the horizontal direction. The coupling extension portion 713 may contact the body 310. For example, the coupling extension portion 713 may contact an upper surface or a lower surface of the second body 313. For example, a seating groove 315 for seating the coupling extension portion 713 may be recessed and formed on the upper surface of the second body 313. A first coupling hole 316 may be formed in the seating groove 315. A second coupling hole 714 aligned with the first coupling hole 316 may also be formed in the coupling extension portion 713. Accordingly, the housing 710 may be coupled to the body 310 as the coupling member passes through the coupling holes 316 and 714. It is also possible for a coupling member passing through the coupling hole 316 and 714 to be coupled to the first door.

The locking unit 70 may further include a locking member connector 720 disposed within the housing 710. The locking member connector 720 may be connected to the locking member 730 inserted into the housing 710. The locking member connector 720 may be connected to the locking member 730 and may rotate together with the locking member 730. The locking member connector 720 may be received in the housing 710 from an upper side of the housing 710 and coupled to the locking member 730 in a state in which the locking member 730 is inserted into the housing 710 through the slot 717. A portion of the locking member connector 720 may pass through the locking member 730 and be coupled to the locking member 730. The locking member connector 720 may be connected to an elastic member 750, which will be described later.

Since a basic structure of the locking member connector 720 may be the same or similar to that of the above-described first connector 340, detailed description will be omitted. The locking member connector 720 may include a lever coupling portion 720a and an elastic member coupling portion 720b.

The locking member 730 may include one or more rib holes 732 into which one or more ribs of the lever coupling portion 720a are inserted.

The locking unit 70 may further include an elastic member 750. The elastic member 750 may be received within the housing 710. A portion of the elastic member 750 may be received in the coupling space of the elastic member coupling portion 720b. The elastic member 750 may be a torsion spring, for example. Since a basic structure of the elastic member 750 may be the same or similar to that of the elastic member 350 received in the body 310, detailed description will be omitted.

The locking unit 70 may further include an elastic member connector 760 coupled to the elastic member 750. Since a basic structure of the elastic member connector 760 of this embodiment may be the same or similar to that of the second connector 360, detailed description will be omitted.

The locking unit 70 may further include a fixing pin 780 for fixing the elastic member connector 760 to the housing 710. A hole 716 may be formed in the housing 710 through which the fixing pin 780 passes. The fixing pin 780 may be coupled to the elastic member connector 760 after passing through the pin hole 716.

A hook 734 may be provided at an end of the locking member 730. A locking groove 323 into which the hook 734 is inserted may be formed in the lever 320. When the hook 734 is inserted into the locking groove 323, the rotation of the lever 320 may be restricted by the locking member 730.

The locking member 730 may include a contact protrusion 735. The contact protrusion 735 may contact the lever 320. For example, the contact protrusion 735 may be in contact with the third portion 324 of the lever 320. The contact protrusion 735 may be located in a portion of the locking member 730 where the locking member coupling portion 720a is coupled or between a rotation center C3 of the locking member 730 and the hook 734.

The locking member 730 may further include a receiving groove 737 for receiving a portion of the lever 320 when the rotation of the lever 320 is restricted. For example, the third portion 324 may be received in the receiving groove 737. The receiving groove 737 may be located between the contact protrusion 735 and the rotation center C3 of the locking member 730.

The third portion 324 may be located on an opposite side of the roller 327 (which is a contact portion of the lever) with respect to the locking groove 323. That is, the locking groove 323 may be disposed between the third portion 324 and the roller 327. A distance from the rotation center C2 to an end of the third portion 324 may be less than a distance from the rotation center C2 to the roller 327 (which is the contact portion of the lever). For example, the contact protrusion 735 may protrude in the horizontal direction from a side surface 736 of the locking member 730. When the hook 734 of the locking member 730 is inserted into the locking groove 323, the third portion 324 may be in contact with the contact protrusion 735. In a state in which the hook 734 of the locking member 730 is inserted into the locking groove 323, the end of the third portion 324 may be received in the receiving groove 737.

The first door 21 may further include a push member 540 that operates to release the locked state of the lever 320 during the process of closing the first door 21. For example, the push member 540 may push the lever 320 in the process of closing the first door 21. The push member 540 may be installed on the hinge bracket 50 or on the cabinet 10. For example, FIG. 3 shows the push member 540 being installed on the coupling portion 510 of the hinge bracket 50.

The push member 540 may include a coupling body 542 coupled to the coupling portion 510. A coupling hole 543 through which a coupling member for coupling to the coupling portion 510 passes may be formed in the coupling body 542.

The push member 540 may further include a push body 544 extending from the coupling body 542. The push body 544 may extend from the coupling body 542 in the horizontal direction. The push body 544 may be positioned at the same height as at least a portion of the lever 320. Therefore, in the process of closing the lever 320, the lever 320 may contact the push body 544. For example, the push body 544 may be positioned at the same height as the roller 327 of the lever 320. The contact surface 576 may also be disposed at the same height as the roller 327. The push body 544 may be arranged to be spaced apart from the contact surface 576 in the horizontal direction. In the process of closing the first door 21, the roller 327 may be disposed in a space between the contact surface 576 and the push body 544. The push body 544 may include a push surface 545 with which the roller 327 comes into contact. The push surface 545 may be an inclined surface or a rounded surface.

In the process of closing the first door 21, the roller 327 may be pushed while moving along the push surface 545. In the process of moving the roller 327 along the push surface 545, the roller 327 may be pressed and the lever 320 may be rotated.

The contact surface 576 may include a first surface 576a that the lever 320 initially contacts during the process of closing the first door 21. When the first door 21 is opened at an angle equal to or greater than a predetermined angle, the lever 320 may not be in contact with the first surface 576a. In the process of closing the first door 21, the lever 320 may contact the first surface 576a. At least a portion of the first surface 576a may be a concave surface.

The contact surface 576 may further include a second surface 576b extending from the first surface 576a. The second surface 576b may be disposed to be inclined with respect to the first surface 576a. A curvature of the second surface 576b may be greater than a curvature of the first surface 576a. The contact surface 576 may further include a third surface 576c extending from the second surface 576b. The third surface 576c may be disposed to be inclined with respect to the second surface 576b.

As the first surface 576a approaches the coupling portion 510 (or a front surface of the cabinet 10), the first surface 576a may be inclined in a direction close to an imaginary line A1 perpendicular to the coupling portion 510 and passing through the rotation center C1 of the first door 21. Alternatively, as the first surface 576a approaches the coupling portion 510 (or a front surface of the cabinet 10), the first surface 576a may extend in a direction away from the rotation center C1. The third surface 576c may extend in a direction closer to the imaginary line Al as a distance from the coupling portion 510 increases. Alternatively, the third surface 576c may extend from the second surface 576b in a direction away from the coupling portion 510 (or the front surface of the cabinet 10).

Hereinafter, the operation of the auto closing device 30 will be described.

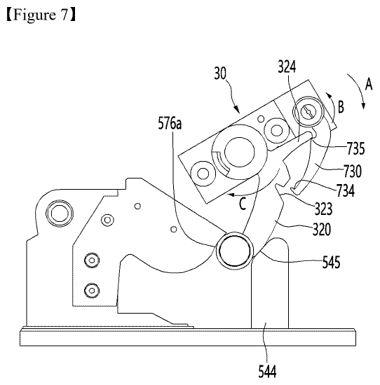

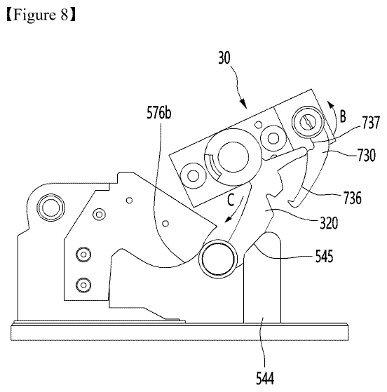

FIG. 7 is a bottom view of an auto closing device and a hinge bracket showing relative positions of the hinge bracket and the auto closing device in a state in which the door is opened by a first angle less than the reference angle, and FIG. 8 is a bottom view of an auto closing device and a hinge bracket showing elative positions of the hinge bracket and the auto closing device in a state in which the door is opened by a second angle less than the first angle.

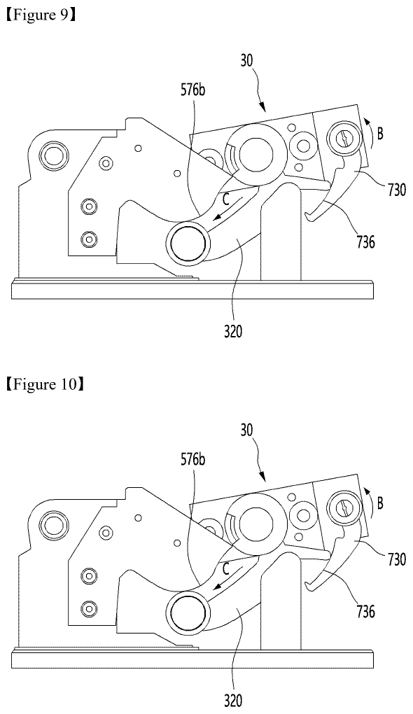

FIG. 9 is a bottom view of an auto closing device and a hinge bracket showing relative positions of the hinge bracket and the auto closing device in a state in which the door is opened by a third angle less than the second angle, and FIG. 10 is a bottom view of an auto closing device and a hinge bracket showing relative positions of the hinge bracket and the auto closing device in a state in which the door is opened by a fourth angle less than the third angle.

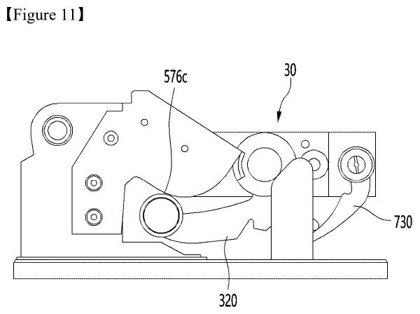

FIG. 11 is a bottom view of an auto closing device and a hinge bracket showing relative positions of the hinge bracket and the auto closing device when the door is closed.

In FIGS. 6 to 11, the door is omitted.

Referring to FIGS. 4 to 11, when the first door 21 is opened at an angle equal to or greater than the reference angle, an insertion of the hook 734 of the locking member 730 into the locking groove 323 of the lever 320 is maintained with the elastic member 350 accumulating elastic force (for example, first elastic force). In this state, a rotation of the lever 320 is restricted.

In a state in which the hook 734 of the locking member 730 is inserted into the locking groove 323 of the lever 320, the third portion 324 of the lever 320 may be in contact with the locking member 730 and an end of the lever may be received in the receiving groove 737.

A distance from the rotation center C2 of the lever 320 to the receiving groove 737 may be greater than a distance from the rotation center C2 of the lever 320 to the contact protrusion 735.

Since the locking member 730 receives elastic force from the elastic member 750, unless an external force is applied to the lever 320 or the locking member 730, an insertion of the hook 734 of the locking member 730 into the locking groove 323 of the lever 320 may be maintained.

In this embodiment, a state in which the hook 734 is inserted into the locking groove 323 may be referred to as a locking state of the lever 320. A state in which the hook 734 is removed from the locking groove 323 may be referred to as an unlocked state of the lever 320.

In this embodiment, a direction in which the locking member 730 is rotated to insert the hook 734 into the locking groove 323 may be referred to as a locking direction. A direction in which the locking member 730 is rotated to remove the hook 734 from the locking groove 323 may be referred to as an unlocking direction.

Referring to FIG. 6, in the process of closing the first door 21 in a A direction (for example, clockwise direction based on FIG. 6), when an opening angle of the first door 21 reaches the reference angle, the lever 320 may contact the push surface 545 of the push body 544.

As the lever 320 contacts the push surface 545 of the push body 544 and the lever 320 rotates, the lever 320 may contact the first surface 576a.

Referring to FIG. 7, in the process of further rotating the first door 21 in THE A direction in a state in which the lever 320 is in contact with the push surface 545, the lever 320 may be pushed by the push surface 545. Then, the lever 320 may be rotated in a C direction (for example, clockwise direction based on FIG. 7) with respect to the rotation center C2.

In the process of rotating the lever 320 in the C direction, the end of the third portion 324 presses the contact protrusion 735 of the locking member 730. Then, the locking member 730 rotates in a B direction (for example, clockwise or unlocking direction based on FIG. 7) with respect to the rotation center C3. That is, the locking member 730 rotates in a direction opposite to the rotation direction of the lever 320. The third portion 324 serves to transmit the rotational force of the lever 320 to the locking member 730.

When the locking member 730 rotates in the B direction, the hook 734 gets out of the locking groove 323. For example, the hook 734 may get out of the locking groove 323 in a state in which the opening angle of the first door 21 is a first angle less than the reference angle.

When the hook 734 gets out of the locking groove 323, the lever 320 becomes rotatable in the C direction. In a state in which the hook 734 gets out of the locking groove 323, the lever 320 is in contact with the first surface 576a.

When the first surface 576a is a concave surface and while the lever 320 is pressed and rotated by the push surface 545, the lever 320 may move along the first surface 576a while maintaining contact with the first surface 576a.

Since the locked state of the lever 320 is released at the position shown in FIG. 7, the lever 320 may be rotated in the C direction by the elastic force of the elastic member 350. In this state, even if the user does not provide closing force to the first door 21, the first door 21 can be automatically closed by the auto closing device 30.

As shown in FIG. 8, when the first door 21 is further rotated in the A direction, the lever 320 may be spaced apart from the push surface 545. Since the lever 320 receives the elastic force of the elastic member 350, the lever 320 can move along the first surface 576a to the second surface 576c.

As shown in FIG. 8, in the process of moving the lever 320 from the first surface 576a to the second surface 576b, the third portion 324 gets out of the receiving groove 737 and may be in contact with the side surface 736 of the locking member 730. At least a portion of the side surface 736 may be a rounded surface that is rounded in a direction away from the rotation center C2.

Referring to FIGS. 9 to 11, the lever 320 may continuously rotate in the C direction and move along the second surface 376b due to the elastic force of the elastic member 350.

The elastic force of the elastic member 350 decreases as a cumulative rotation angle (during closing process) in the C direction of the lever 320 increases. The decreasing elastic force of the elastic member 350 acts as a closing force of the first door 21.

As shown in FIG. 11, when the lever 320 passes the second surface 376b and contacts the third surface 376c, the first door 21 is completely closed. In the process of closing the first door 21, the locking member 730 may be continuously rotated in the unlocking direction, or the rotation of the locking member 730 may be stopped just before the first door 21 is closed, or the locking member 730 may be rotated in the locking direction just before the first door 21 is closed.

As shown in FIG. 11, in a state in which the first door 21 is completely closed, the lever 320 may substantially rotates at a predetermined angle with respect to the body 310, and thus, the elastic member 350 may be maintained to accumulate a second elastic force having a predetermined intensity. Here, the second elastic force is less than the first elastic force but greater than zero.

Therefore, since the elastic member 350 applies force in the direction in which the first door 21 is closed in the state in which the first door 21 is closed, the closed state of the first door 21 may be stably maintained.

According to this embodiment, in a state in which the first door 21 is opened at an angle equal to or greater than the reference angle, the lever 320 may be in the locked state in a state in which the elastic member 350 accumulates the first elastic force.

In this state, to close the first door 21, when the user rotates the first door 21 from the reference angle by a difference between the reference angle and the first angle, the locking of the lever 320 may be released. The difference between the reference angle and the first angle is not limited, but may be about 5 degrees or less.

Therefore, if the user rotates the first door 21 only at an angle of about 5 degrees or less from the reference angle, the user may not have to additionally apply force for closing the first door 21 to the first door 21, the user may close the first door with little force.

In the state in which the locking of the lever 320 is released, the first door 21 may be automatically closed by the elastic force of the elastic member 350 even if the user does not manually close the first door 21. Thus, when the user releases the first door 21 in the process of closing the first door 21, the first door 21 may be prevented from being maintained in the opened state.

A case in which the first door 21 is opened will be briefly described.

When the first door 21 is opened while the first door 21 is closed, the lever 320 may rotate in a counterclockwise direction with respect to the body 310. When the lever 320 rotates in the counterclockwise direction with respect to the body 310, the elastic force of the elastic member 350 may increase from the second elastic force. When the opening angle of the first door 21 increases, the rotational angle of the lever 320 increases, and the elastic force of the elastic member 350 may continuously increase.

In the process of increasing the opening angle of the first door 21, when the lever 320 is rotated, the locking member 730 rotates in the locking direction (clockwise direction in the drawing). When the opening angle of the first door 21 increases and the opening angle becomes the first angle, the lever 320 comes into contact with the push surface 545, and the third portion 324 may be received in the receiving groove 737 after passed the contact protrusion 735. In this state, the hook 734 is located adjacent to the locking groove 323.

In the process of increasing the opening angle of the first door 21 from the first angle to the reference angle, the hook 734 may be inserted into the locking groove 323. When the first door 21 is opened at a reference angle, the hook 734 is inserted into the locking groove 323, and the elastic force of the elastic member 350 is accumulated as the first elastic force, and the rotation of the lever 320 may be restricted.

Meanwhile, in the above embodiment, it was explained that the push member 540 pushes the lever 320 during the closing process of the first door 21. However, unlike this, the push member 540 may push the locking member 730. In this case, the locking member 730 may be provided with an extension portion, and during the process of closing the first door 21, the push member 540 pushes the extension portion so that the locking member 730 may be rotated in the unlocking direction.

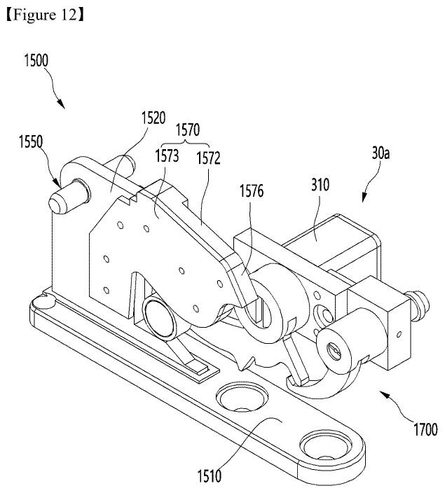

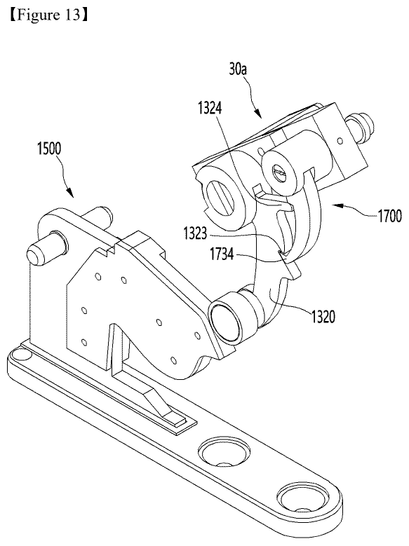

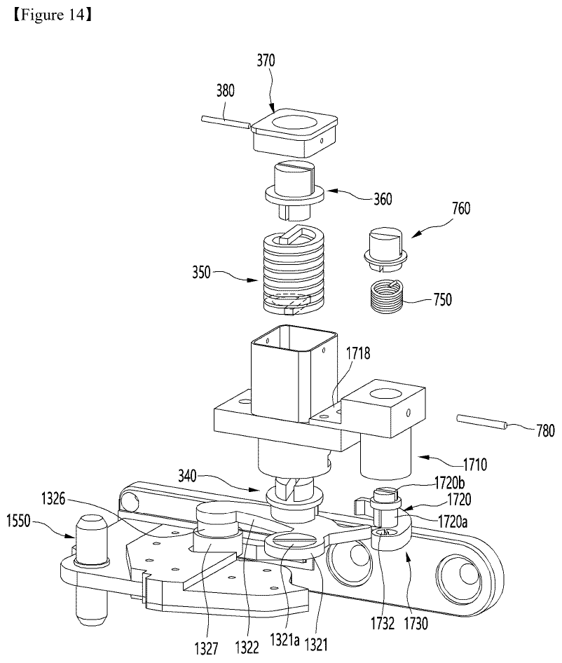

FIG. 12 is a perspective view showing relative positions of a hinge bracket and an auto closing device in a state in which the door is closed according to a second embodiment of the present invention, FIG. 13 is a perspective view showing relative positions of a hinge bracket and an auto closing device in a state in which the door is opened at a reference angle according to a second embodiment, and FIG. 14 is an exploded perspective view of an auto closing device according to a second embodiment.

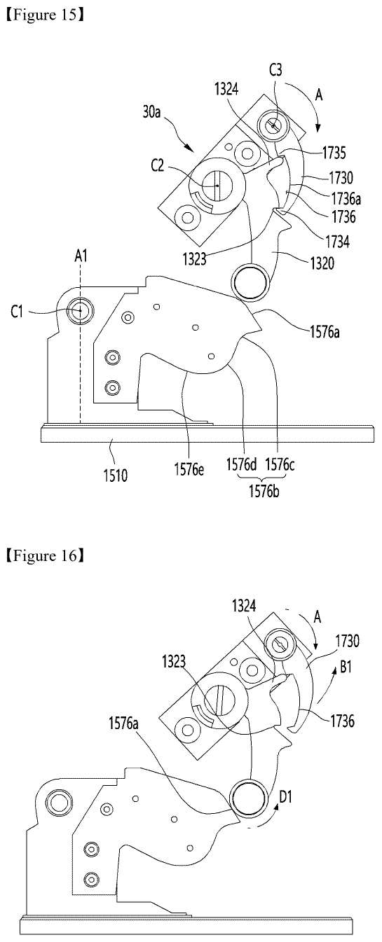

FIG. 15 is a bottom view of an auto closing device and a hinge bracket showing relative positions of the hinge bracket and the auto closing device in a state in which the door is opened at a reference angle according to a second embodiment.

This embodiment is the same as the previous embodiment in others, but there are differences in locking member and shape of the lever. Hereinafter, characterized portions according to the current embodiment will be principally described. The same components as in the first embodiment will use the same references.

Referring to FIGS. 12 to 15, the refrigerator of this embodiment may include a hinge bracket 1500 and an auto closing device 30a.

The hinge bracket 1500 of this embodiment may include a coupling portion 1510 for being coupled to the cabinet 10, and a bracket body 1520 extending from the coupling portion 1510 in a horizontal direction. The hinge bracket 1500 may further include a shaft member 1550.

Since the hinge bracket 1500 of this embodiment is the same or similar to the hinge bracket of the first embodiment, a detailed description will be omitted.

The hinge bracket 1500 may further include a cam member 1570 detachably coupled to the bracket body 1520.

The cam member 1570 may include a contact surface 1576 for contacting the lever 320. A basic structure of the cam member 1570 may be the same as the cam member of the first embodiment.

The cam member 1570 may include a first cam body 1572 and a second cam body 1573 coupled to the first cam body 1572. The first cam body 1572 and the second cam body 1573 may be coupled by a coupling member via the bracket body 1520.

Hereinafter, the auto closing device 30a will be described in detail.

The auto closing device 30a of this embodiment may include a body 310.

The auto closing device 30a may further include a lever 1320 rotatably coupled to the body 310. The auto closing device 30a may further include an elastic member 350 connected to the lever 1320.

The body 310 of this embodiment may be the same as the body of the first embodiment.

The auto closing device 30a may further include a first connector 340 disposed within the body 310. The first connector 340 may be connected to the lever 1320 inserted into the body 310. The first connector 340 may connect the elastic member 350 to the lever 1320.

The lever 1320 may include a first portion 1321 coupled to the first connector 340. The first portion 1321 may also be referred to as a connector coupling portion.

The lever 1320 may further include a second portion 1322 extending from the first portion 1321 in the horizontal. The lever 1320 may further include a contact portion for contacting the bracket body 1520. The contact portion may be a roller 1327.

The lever 1320 may further include an extension portion 1324 extending from the first portion 1321 in a direction different from that of the second portion 1322. The extension portion 1324 may function with a locking member 1700, which will be described later.

Since the elastic member 350 of this embodiment is the same as the elastic member of the first embodiment, detailed description will be omitted.

The auto closing device 30a may further include a second connector 360. Since the second connector 360 of this embodiment is the same as the second connector of the first embodiment, detailed description will be omitted.

The auto closing device 30a may further include an upper cap 370 that covers an upper opening of the body 310. The auto closing device 30a may further include a fixing pin 380 for fixing the upper cap 370 to the body 310.

The auto closing device 30a may further include a locking unit 1700. The locking unit 1700 may limit a rotation of the lever 1320 when the first door 21 is opened at an angle equal to or greater than a predetermined angle.

The locking unit 1700 may include a locking member 1730 that is rotatable with respect to the lever 1320. The locking member 1730 may be rotated independently of the lever 1320. The locking member 1730 may be coupled to or disengaged from the lever 1320. For example, the locking member 1730 may be rotated with respect to a rotation center C3 spaced apart from the rotation center C2 of the lever 1320. At this time, the rotation center C2 of the lever 1320 may be disposed between the rotation center C1 of the first door 21 and the rotation center C1 of the locking member 1730.

In a state in which the locking member 1730 is coupled to the lever 1320, a rotation of the lever 1320 may be restricted. In a state in which the locking member 1730 is disengaged from the lever 1320, the lever 1320 may be rotated.

The locking unit 1700 may further include a housing 1710 to which the locking member 1730 is rotatably connected. Since a basic structure of the housing 1710 is the same as that of the first embodiment, detailed description will be omitted.

The housing 1710 may include a coupling extension portion 1718 extending in the horizontal direction. The coupling extension portion 1718 may contact the body 310. For example, the coupling extension portion 1718 may contact an upper surface or a lower surface of the second body 313.

The locking unit 1700 may further include a locking member connector 1720 disposed within the housing 1710. The locking member connector 1720 may be connected to the locking member 1730 and may rotate together with the locking member 1730.

Since the locking member connector 1720 is the same as the locking member connector of the first embodiment, detailed description will be omitted.

The locking unit 1700 may further include an elastic member 750. The locking member connector 1720 may be connected to the elastic member 750.

A basic structure of the elastic member 750 may be the same or similar to that of the elastic member 350 accommodated in the body 310.

The locking unit 1700 may further include an elastic member connector 760 coupled to the elastic member 750. A basic structure of the elastic member connector 760 of this embodiment may be the same or similar to that of the second connector 360.

The locking unit 1700 may further include a fixing pin 780 for fixing the elastic member connector 760 to the housing 1710.

A hook 1734 may be provided at an end of the locking member 1730. A locking groove 1323 into which the hook 1734 is inserted may be formed in the lever 1320. In a state in which the hook 1734 is inserted into the locking groove 1323, the rotation of the lever 1320 may be restricted by the locking member 1730.

The extension portion 1324 may be disposed at an opposite side of the roller 1327 (which is a contact portion of the lever) with respect to the locking groove 1323. That is, the locking groove 1323 may be located between the extension portion 1324 and the roller 1327.

The locking member 1730 may include a receiving groove 1736 for receiving the extension portion 1324 of the lever 1320. The receiving groove 1736 may be disposed between the rotation center C3 of the locking member 1730 and the hook 1734. The receiving groove 1736 may be formed as one side of the locking member 1730 is depressed toward the other side. The depressed surface 1736a of the receiving groove 1736 (or the surface forming the receiving groove) may be rounded. For example, the depressed surface 1736a may be rounded or rounded to be convex in a direction away from the rotation center C2 of the lever 1320.

A contact protrusion 1735 may be formed in the receiving groove 1736 adjacent to the rotation center C3 of the locking member 1730. That is, the contact protrusion 1735 may be disposed between the receiving groove 1736 and the rotation center C3 of the locking member 1730. The locking member 1730 may be rotated when an end of the extension portion 1324 gets out of the receiving groove 1736 and comes into contact with the contact protrusion 1735.

Meanwhile, the contact surface 1376 may include a first surface 1576a that the lever 1320 initially contacts during the process of closing the first door 21.

When the first door 21 is opened at an angle greater than the reference angle, the lever 1320 is not in contact with the first surface 1576a. As the first surface 1576a approaches the coupling portion 1510 (or a front surface of the cabinet 10), the first surface 1576a may be inclined in a direction away from an imaginary line A1 perpendicular to the coupling portion 1510 and passing through the rotation center C1 of the first door 21. Alternatively, as the first surface 1576a approaches the coupling portion 1510 (or a front surface of the cabinet 10), the first surface 1576a may extend in a direction away from the rotation center C1.

The contact surface 1576 may further include a second surface 1576b extending from the first surface 1576a. The second surface 1576b may be inclined with respect to the first surface 1576a. As the second surface 1576b approaches the coupling portion 1510 (or a front surface of the cabinet 10), second surface 1576 b may be inclined in a direction closer to the imaginary line A1. Alternatively, as the second surface 1576b approaches the coupling portion 1510 (or a front surface of the cabinet 10), the second surface 1576b may extend in a direction closer to the rotation center C1.

The contact surface 1576 may further include a third surface 1576e extending from the second surface 1576b. The third surface 1576e may be inclined with respect to the second surface 1576b. The third surface 1576e may be disposed to be inclined not only with the coupling portion 1510 (or the front of the cabinet 10), but also with the imaginary line A1. The third surface 1576e may be inclined in a direction closer to the imaginary line A1 as the distance from the coupling portion 1510 increases. Alternatively, the third surface 1576e may extend from the second surface 1576b in a direction away from the coupling portion 1510 (or the front of the cabinet 10).

The second surface 1576b may include a concave surface 1576c and a convex surface 1576d. The concave surface 1576c is a surface connected to the first surface 1576a. The convex surface 1576c is a surface connected to the third surface 1576e. The lever 1320 may sequentially contact the first surface 1576a, the concave surface 1576c, and the convex surface 5176d and then contact the third surface 1576e.

Hereinafter, the operation of the auto closing device 30a will be described.

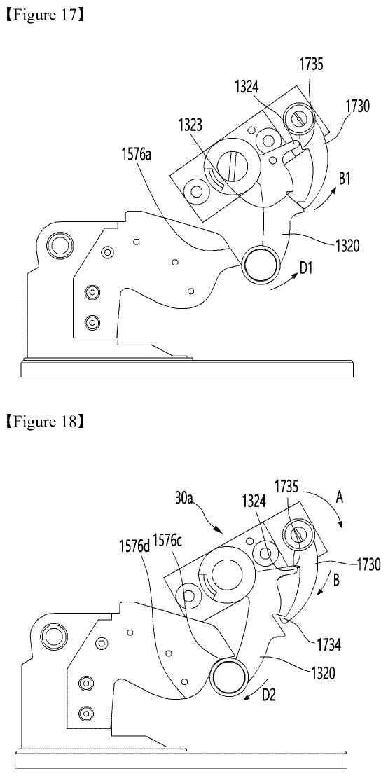

FIG. 16 a bottom view of an auto closing device and a hinge bracket showing relative positions of the hinge bracket and the auto closing device in a state in which the door is opened by a first angle less than the reference angle according to a second embodiment, and FIG. 17 is a bottom view of an auto closing device and a hinge bracket showing relative positions of the hinge bracket and the auto closing device in a state in which the door is opened by a second angle less than the first angle according to a second embodiment.

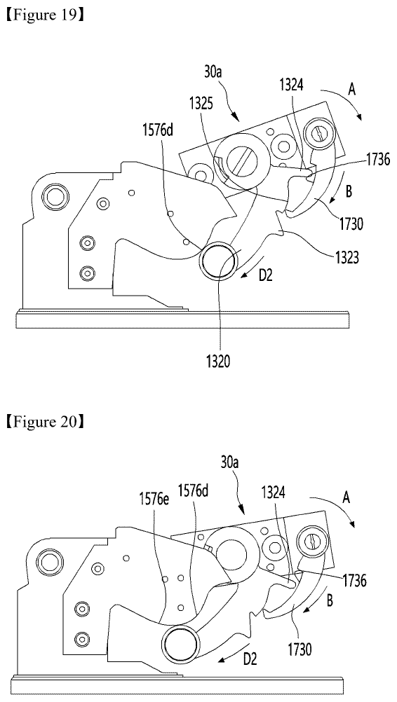

FIG. 18 is a bottom view of an auto closing device and a hinge bracket showing relative positions of the hinge bracket and the auto closing device in a state in which the door is opened by a third angle less than the second angle according to a second embodiment, and FIG. 19 is a bottom view of an auto closing device and a hinge bracket showing relative positions of the hinge bracket and the auto closing device in a state in which the door is opened by a fourth angle less than the third angle, according to a second embodiment.

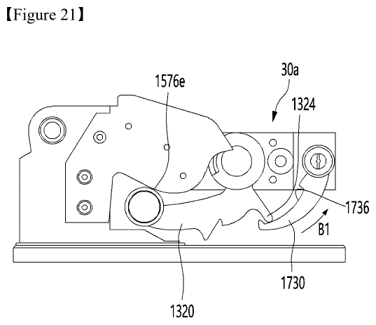

FIG. 20 is a bottom view of an auto closing device and a hinge bracket showing relative positions of the hinge bracket and the auto closing device in a state in which the door is opened by a fifth angle less than the fourth angle according to a second embodiment. FIG. 21 is a bottom view of an auto closing device and a hinge bracket showing relative positions of the hinge bracket and the auto closing device in a state in which the door is closed according to a second embodiment.

In FIGS. 15 to 21, the door is omitted.

Referring to FIGS. 13 to 21, when the first door 21 is opened at an angle equal to or greater than the reference angle, an insertion of the hook 1734 of the locking member 1730 into the locking groove 1323 of the lever 1320 is maintained with the elastic member 350 accumulating elastic force (for example, first elastic force). In this state, a rotation of the lever 320 is restricted.

In a state in which the hook 1734 of the locking member 1730 is inserted into the locking groove 1323 of the lever 1320, the extension portion 1324 of the lever 1320 may be received in a receiving groove 1734 of the locking member 1730.

Since the locking member 1730 receives elastic force from the elastic member 750, unless an external force is applied to the lever 1320 or the locking member 1730, an insertion of the hook 1734 of the locking member 1730 into the locking groove 1323 of the lever 1320 may be maintained.

In this embodiment, a state in which the hook 1734 is inserted into the locking groove 1323 can be referred to as a locking state of the lever 1320. A state in which the hook 1734 is removed from the locking groove 1323 may be referred to as an unlocked state of the lever 1320. In this embodiment, a direction in which the locking member 1730 is rotated to insert the hook 1734 into the locking groove 1323 can be referred to as a locking direction. A direction in which the locking member 1730 is rotated so that the hook 1734 gets out of the locking groove 1323 can be referred to as an unlocking direction.

Referring to FIG. 15, in the process of closing the first door 21 in a A direction (for example, clockwise direction based on FIG. 15), when the opening angle of the first door 21 reaches a reference angle, the lever 1320 is in contact with the first surface 1576a.

Referring to FIG. 16, when the first door 21 is further rotated in the A direction while the lever 1320 is in contact with the first surface 1576a, the lever 1320 rotates in a D1 direction D1 (counterclockwise direction based on 16).

In the process of rotating the lever 1320 in the D1 direction, the extension portion 1324 of the lever 1320 gets out of the receiving groove 1736 and comes into contact with the contact protrusion 1735 to press the contact protrusion 1735. Then, the locking member 1730 is rotated in a BI direction (counterclockwise direction based on FIG. 16) (unlocking direction) with respect to the rotation center C3.

That is, the locking member 1730 rotates in the same direction as the rotation direction of the lever 1320. The extension portion 1324 serves to transmit the rotational force of the lever 1320 to the locking member 1730.

When the locking member 1730 rotates in the B1 direction, the hook 1734 gets out of the locking groove 1323. For example, the hook 1734 may get out of the locking groove 1323 when the opening angle of the first door 21 is a first angle less than the reference angle.

When the hook 1734 gets out of the locking groove 1323, the lever 1320 may be rotatable in the D2 direction. However, since the lever 1320 is in contact with the first surface 1576a in a state in which the hook 1734 gets out of the locking groove 1723, the rotation of the lever 1320 in D2 direction may be restricted.

In the process of rotating the lever 1320 in the D1 direction, the elastic force of the elastic member 350 becomes greater than the first elastic force.

In a state in which the hook 1734 gest out of the locking groove 1323 and as shown in FIG. 17, when the lever 1320 is in contact with the first surface 1576a, the first door 21 may be further rotated in the A direction A (when the opening angle of the first door is the second angle).

Then, the lever 1320 may be disposed at a boundary between the first surface 1576a and the second surface 1576b, and a distance between the hook 1734 and the locking groove 1323 may be increased.

When the opening angle of the first door 21 is the second angle, the elastic force of the elastic member 350 may be maximized.

When the lever 1320 moves along the first surface 1576a, the rotation angle of the locking member 730 in the B1 direction may be greater than the rotation angle of the lever 1320 in the D1 direction. The reason is that the hook 1734 may be easily get out of the locking groove 1323 when the lever 1320 is rotated in the D1 direction.

The reason why the lever 1320 is further rotated in the D1 direction and the locking member 1730 is further rotated in the B1 direction while the hook 1734 gest out of the locking groove 1323 is for preventing the preventing the hook 1734 of the locking member 1730 from being inserted into the locking groove 1723 when the lever 420 rotates in a direction opposite to the D1 direction (clockwise direction in the drawing) as shown in FIG. 18 to automatically close the first door 21.

Referring to FIG. 18, when the first door 21 is further rotated in the A direction in the state in which the lever 1320 is disposed at the boundary between the first surface 1576a and the second surface 1576b (a state where the opening angle of the first door is the third angle), the lever 1320 is rotated in the D2 direction (clockwise direction based on FIG. 18) and the lever 130 may be in contact with the second surface 1576b. At this time, the lever 3120 first contacts the concave surface 1576c at the second surface 1576b.

In a state in which the lever 1320 is in contact with the second surface 1576b, the extension portion 1324 may be received in the receiving groove 1736 of the locking member 730 again. Accordingly, since the force pressing the contact protrusion 1735 is removed, the locking member 1730 may be rotated in a B direction (clockwise direction based on FIG. 18), which is opposite to the BI direction, by the elastic force of the elastic member 750

When the second surface 1576b adjacent to the first surface 1576a includes a concave surface 1576c, the lever 1320 passes the boundary between the first surface 1576a and the second surface 1576b. Then, the lever 1320 and the locking member 1730 rotate in the process of moving along the concave surface 1576c. Due to the difference in speed, the hook 1734 of the locking member 1730 may be prevented from being inserted into the locking groove 1323.

Since the locked state of the lever 1320 is released at the position shown in FIG. 18, the lever 1320 may be rotated in the D2 direction by the elastic force of the elastic member 1350. In this state, even if the user does not provide closing force to the first door 21, the first door 21 can be automatically closed by the auto closing device 30a.

Referring to FIG. 19, when the first door 21 is further rotated in direction A by the elastic force of the elastic member 350 while the lever 1320 is in contact with the concave surface 1576c (a state where the opening angle of the first door is the fourth angle), the lever 1320 comes into contact with the convex surface 1573d.

In a state in which the lever 1320 is in contact with the convex surface 1573d, the hook 1734 of the locking member 1730 may be in contact a side surface 1325 of the lever 1320. In a state in which the lever 1320 is in contact with the convex surface 1573d, the extension portion 1324 may be spaced apart from the recessed surface 1736c of the receiving groove 1736. The convex surface 1576d serves as a damper to reduce the rotational speed of the lever 1320.

A rotational speed of the lever 1320 may increase while moving along the concave surface 1576c. As the rotational speed of the lever 1320 increases, a closing speed of the first door 21 may increase.

If the lever 1320 moves along the concave surface 1576c and immediately comes into contact with the third surface 1576e, noise may be generated during the closing process of the first door 21. However, if the convex surface 1576d is present next to the concave surface 1576c, the rotational speed of the lever 1320 can be reduced, and thus the closing speed of the first door 21 can be reduced and Noise that may occur when the first door 21 is closed can be eliminated.

In a state in which the lever 1320 is in contact with the convex surface 1576d, the first door 21 may be further rotated in the A direction by the elastic force of the elastic member 350, as shown in FIG. 20 (a state where the opening angle of the first door is the fifth angle).

Then, the lever 1320 may be disposed at a boundary between the second surface 1576b and the third surface 1576e. In this state, the extension portion 1324 may contact the recessed surface 1736c of the receiving groove 1736.

Even in the process of moving the first door 21 from a position shown in FIG. 19 to a position shown in FIG. 20, the locking member 1730 may be rotated in the B direction.

The elastic force of the elastic member 350 decreases as the cumulative rotation angle in the D2 direction of the lever 1320 increases, and the decreasing elastic force of the elastic member 350 acts as a closing force of the first door 21.

Finally, as shown in FIG. 21, the first door 21 may be further rotated in the A direction by the elastic force of the elastic member 350. Then, the lever 1320 comes into contact with the third surface 1576e and the first door 21 is completely closed.

At this time, when the first door 21 is moved from a position of FIG. 20 to a position of FIG. 21, the extension portion 1324 may press the recessed surface 1736c of the receiving groove 1736. In this case, the locking member 1730 may be rotated again in the B1 direction.

Of course, when the first door 21 is moved from the position of FIG. 20 to the position of FIG. 21, the locking member 1730 may continuously rotate in the B direction or a rotation of the locking member 1730 may be stopped.

As shown in FIG. 21, when the first door 21 is completely closed, the lever 1320 may substantially rotated at a predetermined angle with respect to the body 310, and thus, the elastic member 350 may be maintained to accumulate a second elastic force having a predetermined intensity. Here, the second elastic force is less than the first elastic force but greater than zero.

Therefore, since the elastic member 350 applies force in the direction in which the first door 21 is closed in the state in which the first door 21 is closed, the closed state of the first door 21 may be stably maintained.

A case in which the first door 21 is opened will be briefly described.

When the first door 21 is opened while the first door 21 is closed, the lever 1320 may rotate in the D1 direction (in a counterclockwise direction) with respect to the body 1310. When the lever 1320 rotates in the D1 direction (counterclockwise direction) with respect to the body 1310, the elastic force of the elastic member 350 may increase from the second elastic force.

When the opening angle of the first door 21 increases, the rotational angle of the lever 1320 increases, and the elastic force of the elastic member 350 may continuously increase.

In the process of increasing the opening angle of the first door 21, when the lever 1320 is rotated, the locking member 1730 rotates in the unlocking direction (clockwise direction in the drawing).

As the opening angle of the first door 21 increases, the lever 1320 rotates in the D2 direction in the process of contacting the first surface 1376a, and the locking member 1730 may be rotated in the locking direction B.

In the process of increasing the opening angle of the first door 21 from the first angle to the reference angle, the hook 1734 may be inserted into the locking groove 1323.

In a state in which the first door 21 is opened at a reference angle, the hook 1734 is inserted into the locking groove 1323, and the rotation of the lever 1320 may be restricted while the elastic force of the elastic member 350 is accumulated to the first elastic force.

1. A refrigerator comprising:
a cabinet having a storage space;
a hinge bracket coupled to the cabinet and having a contact surface;
a door rotatably coupled to a shaft provided in the hinge bracket and that opens or closes the storage space;
an auto closing device installed on the door at a position spaced apart from a rotation center C1 of the door and that operates to automatically close the door by acting on the hinge bracket in a process of closing the door,
wherein the auto closing device includes a lever that rotates with respect to a rotation center C2 spaced apart from the rotation center C1 of the door,
an elastic member connected to the lever,
a body installed on the door and configured to rotatably support the lever,
a locking member rotatable with respect to a rotation center C3 spaced apart from the rotation center C2 of the lever and coupled to the lever while an elastic force of the elastic member is accumulated or in the process of opening the door to limit a rotation of the lever.

2. The refrigerator of claim 1,
wherein when the door is closed, the elastic force of the elastic member is a second elastic force,
in a state in which the rotation of the lever is limited, the elastic force of the elastic member is a first elastic force greater than the second elastic force, an
the door is opened while the rotation of the lever is restricted.

3. The refrigerator of claim 1,
wherein the auto closing device further includes a housing coupled to the body or the door and that rotatably supports the locking member, and an elastic member that elastically supports the locking member within the housing.

4. The refrigerator of claim 1,
wherein the lever includes a locking groove,
the locking member includes a hook inserted into the locking groove, and
when the hook is inserted into the locking groove, the rotation of the lever is restricted.

5. The refrigerator of claim 4,
wherein in the process of closing the door, the lever is configured to move along the contact surface, and
the lever includes an extension portion configured to rotate the locking member in another direction while the lever is rotated in one direction with respect to the rotation center C2.

6. The refrigerator of claim 5,
wherein the locking groove is defined between a contact portion in contact with the contact surface and the extension portion of the lever, and
a distance from the rotation center C2 to an end of the extension portion is less than a distance from the rotation center C2 to the contact portion of the lever in contact with the contact surface.

7. The refrigerator of claim 5,
wherein the locking member includes a receiving groove in which the extension portion is received in a locked state in which the rotation of the lever is restricted, and
a contact protrusion that is pressed by the extension portion during the rotation of the lever in one direction,
wherein the receiving groove is disposed between the rotation center C3 of the locking member and the contact protrusion.

8. The refrigerator of claim 5,
further comprising a push member that pushes the lever or the locking member to unlock the lever with respect to the locking member during the process of closing the door.

9. The refrigerator of claim 8,
wherein in the process of closing the door, the push member pushes the lever so that the lever is rotated in one direction with respect to the rotation center C2, the locking member is rotated in the other direction with respect to the rotation center C3 by the rotation of the lever in one direction to unlock the lever.

10. The refrigerator of claim 8,
wherein the contact surface includes a first surface in contact with the lever rotated by the push member in the process of closing the door after the door is opened at an angle greater than a reference angle,
a second surface extending to be inclined from the first surface, and
a third surface extending to be inclined from the second surface and in contact with the lever in a state in which the door is closed.

11. The refrigerator of claim 10,
wherein as the first surface approaches a front surface of the cabinet, the first surface extends in a direction closer to the rotation center C1,
as the second surface approaches the front surface of the cabinet, the second surface extends in a direction closer to the rotation center C1 and has a different curvature from the first surface, and
the third surface extends from the second surface in a direction away from the front surface of the cabinet.

12. The refrigerator of claim 10,
wherein the lever is spaced apart from the push member in a process of moving the lever from the first surface to the second surface.

13. The refrigerator of claim 10,
wherein the locking member includes a rounded surface positioned between the hook and the contact protrusion, and
in the process of moving the lever from the first surface to the second surface, the extension portion is in contact with the rounded surface after passed the contact protrusion.

14. The refrigerator of claim 8,
wherein the lever includes a rotatable roller, and
in the process of closing the door, the push member pushes the roller.

15. The refrigerator of claim 8,
wherein the push member is spaced apart from the contact surface in a horizontal direction, and
in the process of closing the door, the lever passes through a space between the push member and the contact surface.
